(19) United States
(12) Patent Application Publication
(10) Pub. No.: US 2003/0090198 A1
(43) Pub. Date: May 15, 2003

(54) Display

(76) Inventor: Mark Aston, Bromley (GB)

Correspondence Address: JONES, WALKER, WAECHTER, POITEVENT, CARRERE, & DENEGRE, L.L.P., 5TH FLOOR, FOUR UNITED PLAZA, 8555 UNITED PLAZA BOULEVARD, BATON ROUGE, LA, 70809, US

(21) Appl. No.: 10/026,919

(22) Filed: Dec. 21, 2001

(30) Foreign Application Priority Data
Nov. 10, 2001 (GB) 0127090.9

(51) Int. Cl. H01J 63/04; H01J 1/62

(52) U.S. Cl. 313/498

(57) ABSTRACT

Three adjacent display tiles 10, each having a mould plastics support 11, a glass panel 12 incorporating the OLED element and an interface pcb 17.

These tiles 10 form part of a full-colour advertising screen of dimensions 1.2 metre by 1.8 metre, used in indoor public places.

This application claims priority to United Kingdom serial number 0127090.9, filed on Nov. 10, 2001 which is hereby incorporated by reference in its entirety. The present invention relates to a display, especially a display incorporating an array of OLED pixels, or an OLED backlight used in conjunction with an array of LCD pixels.

Existing types of display unit (whether incorporating cathode ray tubes, liquid-crystal displays or plasma panels) have a region of no display along their perimeter. Thus, when display units of a given type are bolted together to to form larger display, these dead-areas are plainly visible, dividing up the resultant screen into a grid, thereby limiting the overall effect of the composite screen.

In the last two years, displays incorporating OLED (Organic Light Emitting Device) material have been developed for use in automotive dashboards, instrument panels and car radios in order to make good use of the known charateristics of good power efficiency, thermal stability and extended lifetime.

The present invention provides a display comprising a plurality of display regions, each incorporating Organic Light Emitting Device (OLED) material, each region comprising a plurality of separately addressable pixel elements, one or more of the display region(s) overlying a portion of one or more adjacent display region(s).

Thus, the portion of the display region which is underneath said pixel is not visible to a viewer of the display, so that that portion can be used for wiring connections and leads to that display region without causing any detrimental effect to the overall appearance of the display.

Furthermore, the display area may be arranged such that one or more further display regions overlie part of said first display region(s).

Thus, that portion of the display region of said pixel element can be used for the wiring connections and/or leads to said pixel element.

Thus, preferably, the display array comprises a plurality of display regions of the pixels which overlie part of the display regions of laterally and/or orthogonally adjacent display regions.

The present invention also provides a plurality of substrates, each comprising a first portion to support a display region incorporating an Organic Light Emitting Device (OLED) material with a plurality of separately addressable pixel elements, and a second portion which underlies part of another substrate.

This display may include one or more of the following features:—

The first portion and the second portion of a substrate are not in the same plane;

The first portion and the second portion of a substrate are in substantially parallel planes;

The first and second portions of a substrate are in a stepped relationship;

The first and second portions of a substrate arc arranged generally in a U-shape;

The second portion incorporates wiring and/or electrical connections;

The first portion comprises a substrate to hold a glass panel of OLED material;

The first portion comprises a moulded substrate of plastics material;

A flexible heat seal means to ensure high integrity electrical connections between drive electronics and said pixels.

The present invention is particularly suited to displays for advertising screens in public places, and to displays for customer information at train or bus stations and airports, typically with screens up to 3 metres by 2 metres.

However the present invention is also suited to applications incorporating displays which are smaller or larger than these application; also the present invention is also suited to displays which are of any appropriate shape, for example square or rectangular or have an complex outline, for L-shaped and the perimeter any have side which are straight/and or arcuate.

The present invention is applicable to displays in which illumination is provided soley by the material and also displays in which back lighting of the display is provided. Thus, the present invention includes embodiments wherein the pixel elements operate as a shutter whether soley with the on/off capability or with also a graded grey-scale capability.

In order that the invention may more readily be understood, a description is now given, by way of example only, reference being made to the accompanying drawings, in which:

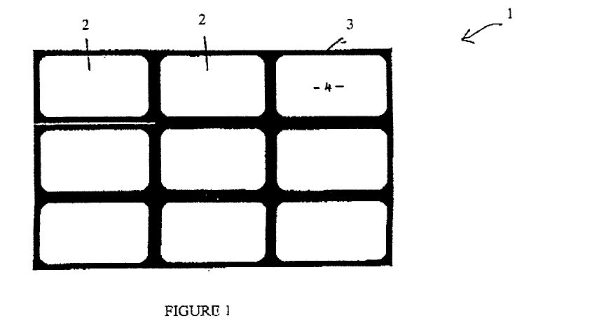

FIG. 1 is a schematic view of part of a conventional tiled display;

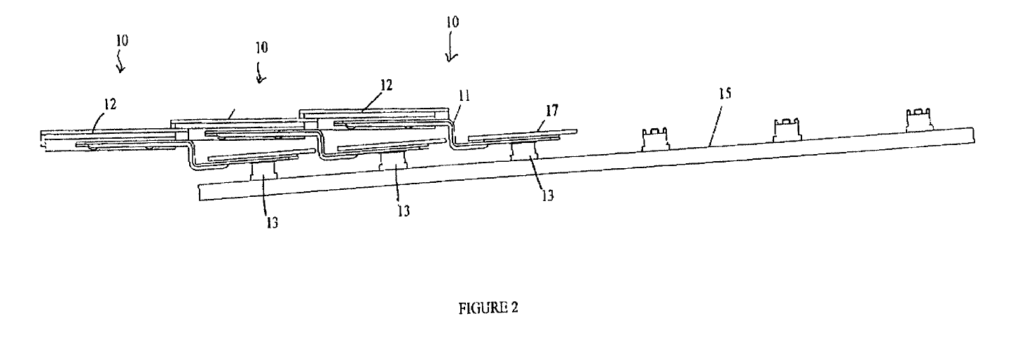

FIG. 2 is a side view of a number of adjacent elements of a display embodying the present invention;

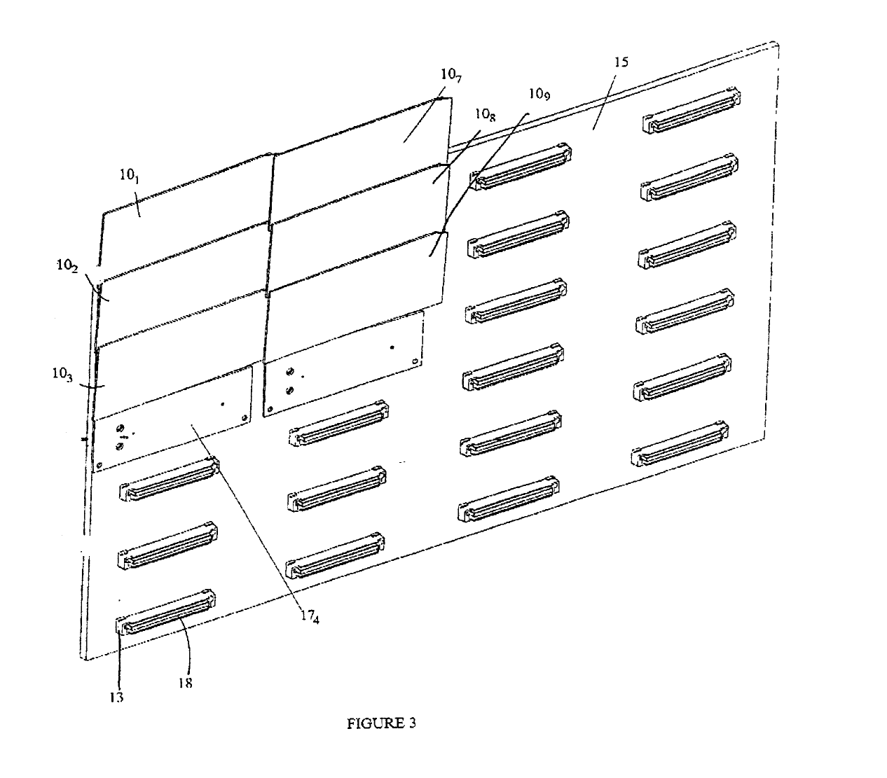

FIG. 3 is a view of part of the front of display of FIG. 2;

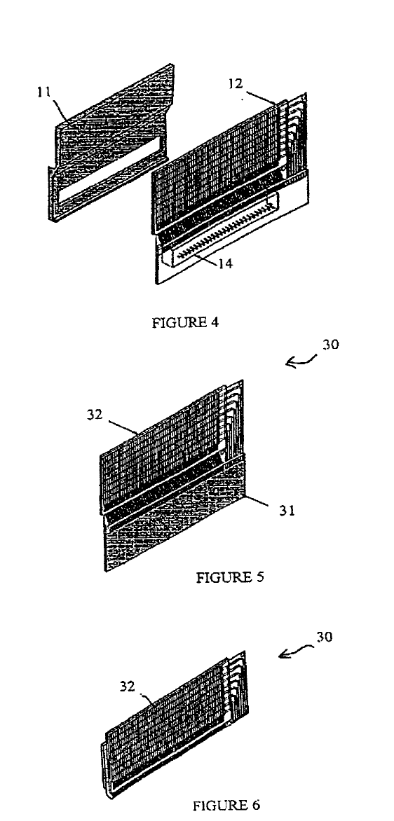

FIG. 4 is a perspective exploded view of an element of FIG. 2;

FIGS. 5 and 6 are perspective views of a second embodiment of element in two states;

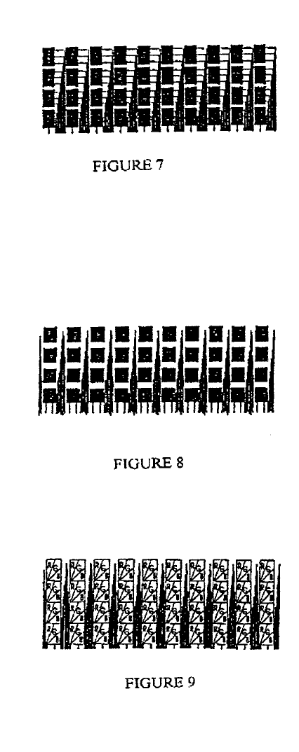

FIGS. 7 to 9 are examples of pixel shapes and direct-addressing arrangements for use in the display of the present invention;

FIG. 10 shows the glass substrate for the display of FIG. 2;

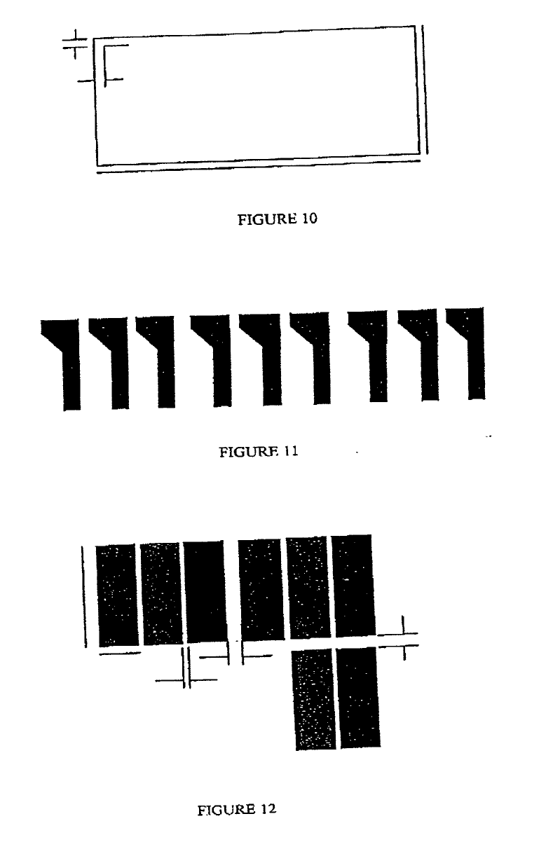

FIG. 11 shows the tracking for the display of FIG. 2;

FIG. 12 shows the pixel layout for the display of FIG. 2;

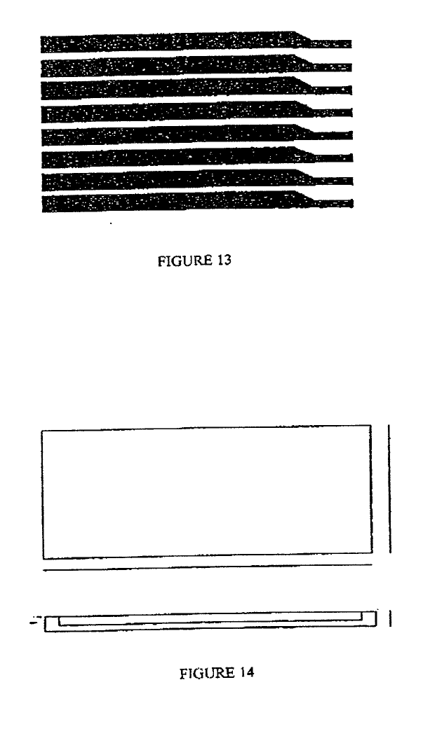

FIG. 13 shows the metal cathode configuration for the display of FIG. 2; and

FIG. 14 shows the encapsulation for FIG. 2.

FIG. 1 illustrates the inherent problem with attempts to form a larger display 1 using discrete displays 2 incorporating known technologies for example cathode ray tubes, liquid crystals and plasma panels. All these technologies have dead areas 3 surrounding the areas 4 which actually represent the image being displayed, such that when a number of displays 2 are bolted together to form a the larger display 1 the dead areas from adjacent displays 2 combine together and become plainly visible, effectively dividing up the screen into a grid array thereby seriously deteriorating the overall effect of the display 1 and detracting from the appearance of the image being displayed.

There is shown in FIG. 2 an arrangement of three adjacent display tiles 10, each having a mould plastics support 11, a glass panel 12 incorporating the OLED element (see FIG. 4) and a interface pcb 17.

These tiles 10 form part of a fill-colour advertising screen of dimensions 1.2 metre by 1.8 metre, used in indoor public places.

Another application for such a display is a Customer Information display, for example for use in train stations, bus stations and airports. The display screen is of any size and shape, from one-character rows to display screens up to typically 3 metre by 2 metre.

The pixel element size is typically in the range of 1 to 10 mm for example 3 mm, and the pixels may be of any colour combination.

The three display tiles 10 are overlapped to eliminate the grid effect, and held in place by mechanical (in the form of posts 13) and electrical interfaces (in the form of electrical connectors 14 and sockets 18) that mount each display tile 10 onto a motherboard 15. The motherboards 15 may also be tiled within a casing to build up screens of virtually any shape and size the design allows for display tiles on one motherboard to overlap with tiles on the second motherboard in the same manner as with each tile on a motherboard.

In this way, dead areas surrounding the active pixel area displayed and necessary to accommodate wiring and/or electrical leads for driving of the pixel elements are hidden behind active image areas, this being made possible by the thin characteristic of OLED devices. The resultant overlap reduces the grid effect seen on other tiled large area displays to a negligible level. This technique applied to both OLED pixel array tiles and LCD tiles using an OLED backlight.

Each display tile 10 is 73.8 mm wide, 33 mm high, and 1.7 mm thick, and 1500 tiles are combined together to form a display area of approximately 1.2 by 1.8 metres.

The support 11 of display tile 10 has a compound angle introduced by overlapping tiles on the bottom and right hand edges on the front face to allow tiling of a number of supports 11. Support 11 holds the glass panel 12 and a connector/printed circuit board provides the compound angle necessary to stack and tile the OLED panels

A heatseal connector (not shown) is arranged in a “L” shape to attach to the bottom and right hand sides of the OLED glass panels 12. These may be any two adjacent sides of the device depending upon which orientation the compound angle and panel overlap is required. If the top and left hand side form heatseal connections instead of the bottom and right hand sides, the overlapping will take place around the new position of the heatseal connections.

FIG. 3 illustrates part of the display screen 20 formed by a 2-dimensional matrix of display tiles. In order to assemble the tiles onto a motherboard 15, the following steps are taken: interface pcb 17₁ is placed on the post 13₁, at the top left-hand-most position on the motherboard 15, then the corresponding tile 10₁, is placed on the interface pcb 17₁.

Thereafter, the same actions are taken in respect of interface pcb 17₂, post 13₂ and tile 10₂ for the next position vertically below but in the same column, and so on until the first column is filled. Then the sequence is repeated for the second column, starting at the top and finishing at the bottom, and being repeated for each column in turn.

In a variant, the tiles 10 are assembled row, by row starting from the top lefthand corner.

In an alternative embodiment of display tile 30, printed circuit board 31 is folded under the glass OLED panel 32 (see FIGS. 5 and 6), a modified moulded plastics support 33 providing the required compound angle and holding the printed circuit board 31 which is appropriately dimensioned to ensure that there is no conflict with other printed circuit boards from adjacent tiles 30.

In a further alternative embodiment, there is no printed circuit board and connector, the heatseal is plugged directly into the motherboard, removing the need of a separate connector and making the arrangement more cost effective and producing a thinner screen.

For direct pixel addressing applications, only one side of the OLED glass panels 12 is required for heatseal bonding, to accommodate the tracking in-between the active pixels. FIGS. 7 to 9 show some of the possible arrangements for direct addressing.

A display tile 10 is not reliant upon any particular defined pixel layout. In order to produce full colour displays, it is necessary to use red, green and blue pixel elements as a minimum. There may also be cases where a further white element is used to increase the white saturation of the image. For the backlight application, any colour or areas of colour may be used.

Pixel element shapes may be square, rectangular, circular, triangular, oval or indeed any geometric form and size.

The size of the red, green, blue (and white, if included), are in the range of 1 mm pixel pitch to 15 mm pitch, though the present invention is not limited to any pixel size, shape or arrangement. Dimensions of the backlighters for those embodiments are the same as the particular size of LCD tile used for the application.

FIG. 10 shows a colour pixel OLED glass panel 12 formed from a glass substrate being a rectangular section of glass, 0.7 mm thick. The dimensions of the glass are illustrated below, including the positioning of the first upper left-hand corner of the pixel array.

Upon the glass substrate, the device is built up in the following layers:—

1. ITO anode

2. Organic stack (pixels)

3. Metal cathode

4. Encapsulation

All of the tracks are 1 mm wide and fall directly onto the vertical layout of the pixels (organic stack). The ITO tracks comprise groups of three 1 mm tracks, each track being 0.1 mm apart, with each group of three being 0.2 mm apart. The first track on the left-hand side starts in the same location as indicated for the pixels on the definition of the glass substrate.

The length of each track is 27.2 mm, such that each track is visible by 0.2 mm below the bottom row of pixels.

In the next 0.8 mm, the tracking is reduced in width gradually until it is 0.5 mm. In the remaining 2 mm of glass, the tracks is bunched together to form 0.5 mm ITO with 0.6 mm gap in a RGB group of 0.7 mm in-between RGB groups. This is repeated for the entire length of the new connector region (see FIG. 11).

The pixels are formed into an array of 20×8 (67.8 mm×27 mm). The pixel pitch is 3.4 mm, with a fill-factor of 83% (see FIG. 12).

The metal cathode layer comprises no more that eight strips each 3.2 mm wide, 0.2 mm apart, starting in exactly the same place at the top left-hand pixel (see FIG. 13).

This time, the tracking protrudes 0.2 mm from the edge of the last column of pixels, reducing from 3.2 mm to 1 mm width within 0.8 mm and remaining a constant 1 mm width for the remaining 2 mm until the edge of the glass is reached.

The encapsulation is located 1 mm in from the top and 1 mm from the left side of the glass substrate.

1. A display comprising a plurality of display regions, each incorporating Organic Light Emitting Device (OLED) material, each region comprising
a plurality of separately addressable pixel elements,
one or more of the display region(s) overlying a portion of one or more adjacent display region(s).

2. A display according to claim 1 wherein one or more further display regions overlie part of said first display region(s).

3. A display array according to claim 1 wherein the portions of display areas which lie underneath other display areas incorporate wiring and/or electrical connections.

4. A display according to claim comprising a plurality of display regions which overlie part of the display regions of laterally and/or orthogonally adjacent display regions.

5. A display according to claim wherein the display regions form a substantially continuous display surface over the array.

6. A display comprising a plurality of substrates, each comprising a first portion to support a display region incorporating an Organic Light Emitting Device (OLED) material with a plurality of separately addressable pixel elements, and a second portion which underlies part of another substrate.

7. A display according to claim 6 wherein the first portion and the second portion of a substrate are not in the same plane.

8. A display according to claim 7 wherein the first portion and the second portion of a substrate are in substantially parallel planes.

9. A display according to any one or more of claims 8 wherein the first and second portions of a substrate are in a stepped relationship.

10. A display according to any one or more of claims 9 wherein the first and second portions of a substrate are arranged generally in a U-shape.

11. A display according to any one or more of claims 10 wherein the second portion incorporates wiring and/or electrical connections.

12. A display according to any one or more of claims 11, wherein the first portion comprises a substrate to hold a glass panel of OLED material.

13. A display according to any one or more of claims 12 wherein the first portion comprises a moulded substrate of plastics material.

14. A display according to any one or more of claims 13 comprising heat seal means to ensure high integrity connection of display to drive electronics.

15. A display according to claim wherein the pixel elements have integral means to generate illumination.

16. A display according to claim comprising means to effect back lighting illumination of a plurality of pixel elements.

17. A display element comprising a substrate for a display according to any preceding claim, the substrate comprising a first portion to support a display region incorporating an Organic Light Emitting Device (OLED) material with a plurality of separately addressable pixel elements, or an OLED backlight, and a second portion to underlie part of another substrate.
